(19) United States
(12) Patent Application Publication
(10) Pub. No.: US 2014/0244947 A1
(43) Pub. Date: Aug. 28, 2014

(54) MEMORY, MEMORY SYSTEM INCLUDING THE SAME, AND OPERATION METHOD OF MEMORY CONTROLLER

(71) Applicant: SK HYNIX INC., Icheon (KR)

(72) Inventor: Keun-Soo SONG, Icheon (KR)

(21) Appl. No.: 13/929,738

(22) Filed: Jun. 27, 2013

(30) Foreign Application Priority Data
Feb. 28, 2013 (KR) 10-2013-0022061

(51) Int. Cl. G06F 9/44

(52) U.S. Cl. CPC G06F 9/4421
USPC 711/154

(57) ABSTRACT

A memory system includes a memory including a condition detection circuit configured to detect a memory condition, and a condition output circuit configured to output the memory condition detected by the condition detection circuit. A memory controller is configured to adjust operational performance of the memory in response to the memory condition.

### CROSS-REFERENCE TO RELATED APPLICATION

The present application claims priority of Korean Patent Application No. 10-2013-0022061, filed on Feb. 28, 2013, which is incorporated by reference herein in its entirety.

### BACKGROUND

1. Field

Exemplary embodiments of the present disclosure relate to a memory, a memory controller, and a memory system including the same.

2. Description of the Related Art

Typically, a memory controller controls a memory such as a dynamic random access memory (DRAM). The memory controller may exist in the form of a chipset on a PC board, in a central processing unit (CPU), or in a graphic processing unit (GPU).

A plurality of memories that are fabricated from different wafers may show performance variations, which may result from variations in process parameters during the memory fabrication process. The performance variations of the plurality of memories may also depend on variations in voltage and temperature conditions of the memories during an operation process.

In order to avoid malfunctioning of a memory system including the plurality of memories, the memory system needs to take account for the memory having the worst performance. As a result, the memory system needs to operate at a substantially lower speed than a speed corresponding to the other memories having better performance.

### SUMMARY

An embodiment of the present disclosure is directed to a system and method to adjust operational performance of a memory using condition information related to the performance of the memory.

In accordance with an embodiment, a memory system includes: a memory including a condition detection circuit configured to detect a memory condition and a condition output circuit configured to output the memory condition detected by the condition detection circuit; and a memory controller configured to adjust operational performance of the memory in response to the memory condition.

The memory condition may include one or more of temperature information, process information, and voltage information. Furthermore, the memory controller may adjust the operational performance of the memory by adjusting one or more of a clock frequency of the memory, a latency of the memory, and a pattern of a command that is applied to the memory, in response to the memory condition.

In accordance with another embodiment, a memory includes: a temperature detection unit configured to detect a temperature of the memory; a process detection unit configured to detect a process variation of the memory; a voltage detection unit configured to detect a power supply voltage of the memory; and a condition output circuit configured to output a memory condition including detection results obtained by the temperature detection unit, the process detection unit, and the voltage detection unit.

In accordance with another embodiment, an operation method of a memory controller includes: receiving a memory condition from a memory; determining whether the memory condition is in a bad condition; and adjusting performance of the memory when it is determined that the memory condition is in the bad condition.

According to the present disclosure, the operational performance of the memory is adjusted according to the memory condition received from the memory, so that it is possible to optimize the operational performance of the memory.

Furthermore, when a plurality of memories are provided in the memory system, it is possible to independently optimize optimal performance of each memory.

### BRIEF DESCRIPTION OF THE DRAWINGS

FIG. 1 is a block diagram of a memory system in accordance with an embodiment.

FIG. 2 is a block diagram of a memory in accordance with an embodiment.

FIG. 3 is a block diagram of a condition detection circuit in accordance with an embodiment.

FIG. 4 is a block diagram of a process detection unit in accordance with an embodiment.

FIG. 5 is a block diagram of a voltage detection unit in accordance with an embodiment.

FIG. 6A and FIG. 6B are diagrams illustrating transmission of a memory condition CONDITION from a memory to a memory controller.

FIG. 7 is a flowchart illustrating an embodiment in which a memory controller adjusts the operational performance of a memory in response to a memory condition received from the memory.

FIG. 8 is a diagram illustrating that a frequency of a clock CLK applied to a memory is adjusted by a memory controller.

FIG. 9 is a diagram illustrating that write latency WL of a memory is adjusted by a memory controller.

FIG. 10 is a diagram illustrating that a command pattern applied to a memory is adjusted by a memory controller.

FIG. 11 is a block diagram of a memory system in accordance with another embodiment.

### DETAILED DESCRIPTION

Embodiments will be described below in more detail with reference to the accompanying drawings. The present disclosure may, however, include embodiments in different forms and should not be construed as limited to the embodiments set forth herein. Rather, these embodiments are provided so that this disclosure will be thorough and complete, and will fully convey the scope of the present disclosure to those skilled in the art. Throughout the disclosure, like reference numerals refer to like parts throughout the various figures and embodiments of the present disclosure.

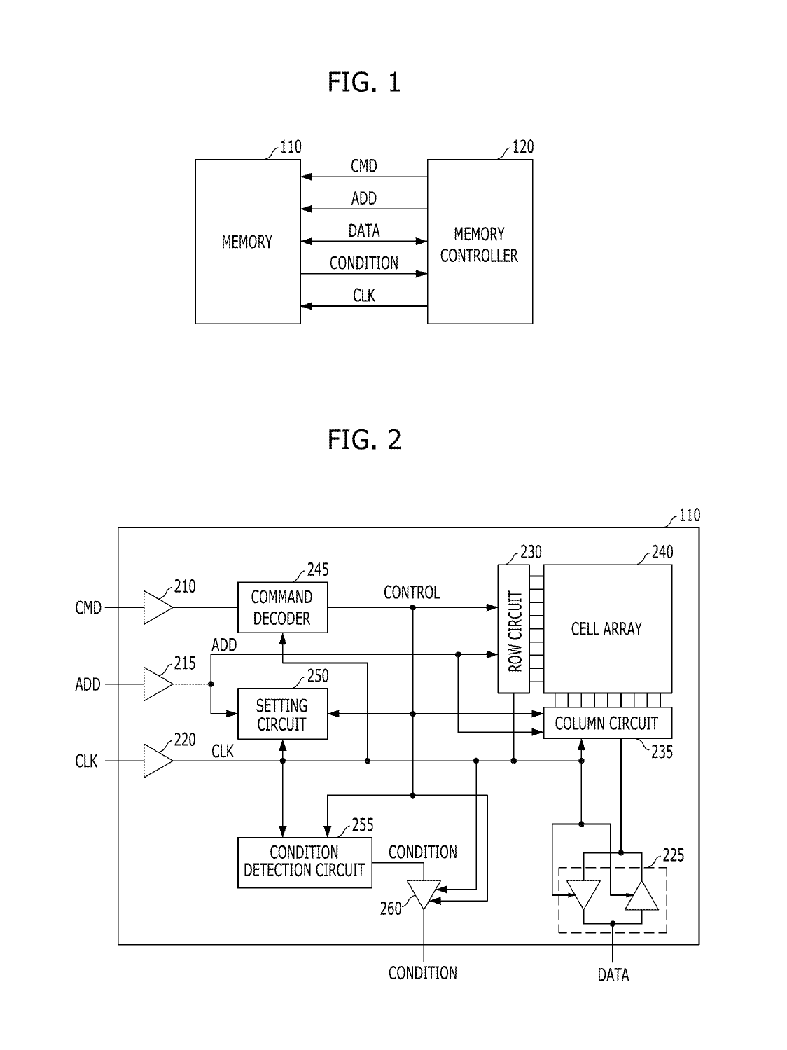

FIG. 1 is a block diagram of a memory system in accordance with an embodiment.

Referring to FIG. 1, the memory system includes a memory 110 and a memory controller 120.

The memory 110 is configured to operate under the control of the memory controller 120. The memory 110 performs an operation (e.g., an active, read, write, precharge, refresh, or mode register setting (MRS) operation) in response to a command CMD applied to the memory 110 from the memory controller 120. The memory 110 uses an address ADD to access a memory cell corresponding to the address ADD in a cell array of the memory 110. Data DATA indicates write data transmitted from the memory controller 120 to the memory 110 and read data transmitted from the memory 110 to the memory controller 120. The memory 110 operates in synchronization with a clock CLK applied from the memory controller 120. A memory condition CONDITION transmitted from the memory 110 to the memory controller 120 indicates a condition of the memory 110. For example, the memory condition CONDITION includes one or more of temperature information, process information, and voltage information of the memory 110.

The memory controller 120 is configured to apply the command CMD, the address ADD, and the clock CLK to the memory 110, and to exchange the data DATA with the memory 110. Meanwhile, the memory controller 120 receives the memory condition CONDITION from the memory 110. The memory controller 120 determines whether the current condition of the memory 110 is in a good or bad condition using the information CONDITION. Based on the decision, the memory controller 120 may adjust the operational performance of the memory 110. In an embodiment, the adjustment of the operational performance of the memory 110 by the memory controller 120 may include adjusting a frequency of the clock CLK, a latency, and a command pattern or sequence. When the condition of the memory 110 is determined to be good, it is possible to further increase the performance of the memory 110 for a faster operation of the memory 110. When the condition of the memory 110 is determined to be bad, it is possible to reduce the performance of the memory 110 for a stable operation of the memory 110.

FIG. 2 is a block diagram of the memory 110 of FIG. 1 in accordance with an embodiment.

Referring to FIG. 2, the memory 110 includes a command input unit 210, an address input unit 215, a clock input unit 220, a data input/output unit 225, a row circuit 230, a column circuit 235, a cell array 240, a command decoder 245, a setting circuit 250, a condition detection circuit 255, and a condition output circuit 260.

The command input unit 210 is configured to receive the command CMD transmitted from the memory controller 120 to the memory 110. FIG. 2 illustrates that the command CMD is inputted through one transmission line. However, when the command CMD includes multi-bit signals, the command CMD may be inputted through a plurality of transmission lines. As shown in FIG. 2, the command CMD passes through the command input unit 210, and then is transmitted to the command decoder 245.

The address input unit 215 is configured to receive the address ADD transmitted from the memory controller 120 to the memory 110. FIG. 2 illustrates that the address ADD is inputted through one transmission line. However, when the address ADD includes multi-bit signals, the address ADD may be inputted through a plurality of transmission lines. After the address ADD passes through the address input unit 215, the address ADD is transmitted to the row circuit 230, the column circuit 235, and the setting circuit 250.

The clock input unit 220 is configured to receive the clock CLK transmitted from the memory controller 120 to the memory 110. Internal elements of the memory 110 operate in synchronization with the clock CLK inputted through the clock input unit 220. In an embodiment, the clock input unit 220 may include a circuit that generates a clock signal to be used inside the memory 110. The clock input unit 220 may include a delay locked loop (DLL) or a phase locked loop (PLL) which generate the internally used clock signal using the clock CLK externally generated from a clock generation system.

The command decoder 245 is configured to decode the command CMD inputted through the command input unit 210, to recognize operations to be performed by the memory 110, and to control the other elements of the memory 110 according to the recognized operations. Examples of the operations to be performed by the memory 110 may include active, precharge, read, write, refresh operations, and a setting operation such as mode register setting (MRS). The elements illustrated in FIG. 2 connected to the command decoder 245 through a control path CONTROL are controlled by the command decoder 245.

The setting circuit 250 is configured to perform a setting operation (e.g., the MRS operation) by decoding the address ADD input through the address input unit 215, when the setting operation is controlled by the command decoder 245. The setting operation performed by the setting circuit 250 may include setting various voltage levels that are internally used in the memory 110, various types of latency such as write latency (WL) or column address strobe (CAS) latency, a test mode and an operation mode, and the like. Results of these setting operations by the setting circuit 250 are used for setting of internal elements of the memory 110. The setting results from the setting circuit 250 may be transmitted to and used in the internal elements of the memory 110.

The row circuit 230 is configured to perform active, precharge, and refresh operations under the control of the command decoder 245. In the active operation, the row circuit 230 activates a word line, which corresponds to the address ADD that is transmitted from the address input unit 215, among word lines of the cell array 240. In the precharge operation, the row circuit 230 deactivates the activated word line. In the refresh operation, the row circuit 230 sequentially activates the word lines.

The column circuit 235 is configured to perform read and write operations under the control of the command decoder 245. A column is selected among a plurality of columns in the cell array 240 corresponding to the address ADD inputted through the address input unit 215. In the read operation, the column circuit 235 reads data from the selected column in the cell array 240, and transmits the read data to the data input/output unit 225. In the write operation, the column circuit 235 writes data, which is transmitted from the data input/output unit 225, in the selected column in the cell array 240.

The data input/output unit 225 is configured to output read data, which is transmitted from the column circuit 235 to the memory controller 120 in the read operation. In the write operation, the data input/output unit 225 is configured to receive write data, which is transmitted from the memory controller 120 to the column circuit 235 in the memory 110. In FIG. 2, the data input/output unit 225 exchanges data with the memory controller 120 through one transmission line DATA. However, a plurality of transmission lines to transmit multi-bits data (e.g., 8 bits, 16 bits, or 32 bits data) may be formed between the memory 110 and the memory controller 120 to transmit the multi-bits data.

The condition detection circuit 255 is configured to detect the condition CONDITION of the memory 110. The memory condition CONDITION indicates conditions of variables of the memory 110, which may affect the performance of the memory 110. These conditions may include temperature, voltage, and process variations in the memory 110. For example, the condition detection circuit 255 is configured to be able to detect one or more condition of the temperature, voltage, and process variables.

The condition output circuit 260 is configured to output the memory condition CONDITION detected by the condition detection circuit 255 to the memory controller 120. In an embodiment, the condition output circuit 260 may output the memory condition CONDITION in response to a condition information request command that is received from the memory controller 120. Alternatively, the condition output circuit 260 may output the memory condition CONDITION to the memory controller 120 at a predetermined time interval. In another embodiment, the condition output circuit 260 may output the memory condition CONDITION to the memory controller 120 in real time. FIGS. 1 and 2 illustrate that the memory condition CONDITION is transmitted from the memory 110 to the memory controller 120 through a separate channel from other channels through which the command CMD, the address ADD, and the data DATA are transmitted. However, the memory condition CONDITION may be transmitted through a channel through which the command CMD, the address ADD, or the data DATA is also transmitted.

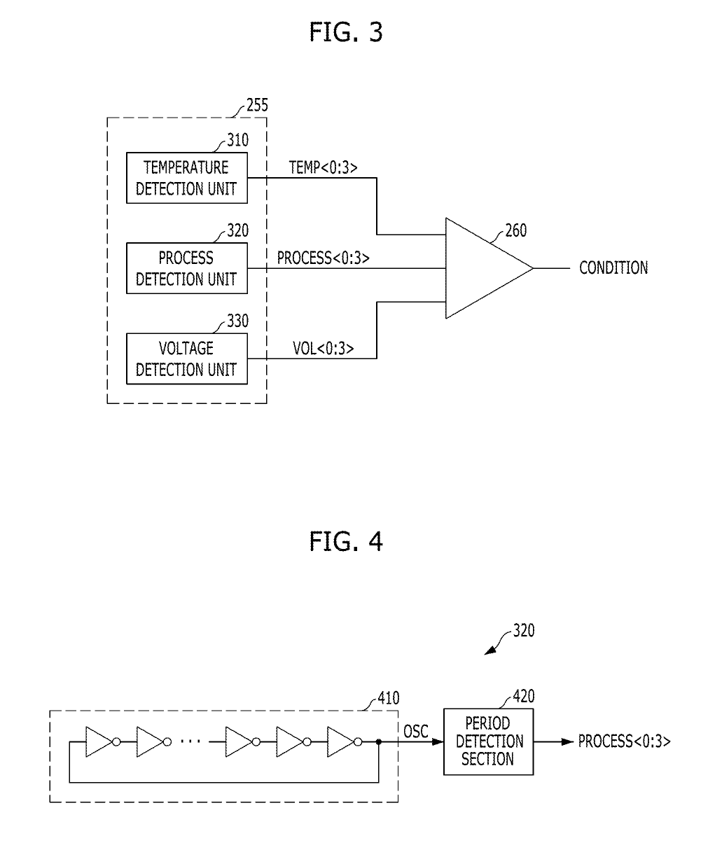

FIG. 3 is a block diagram of the condition detection circuit 255 of FIG. 2 in accordance with an embodiment.

Referring to FIG. 3, the condition detection circuit 255 includes a temperature detection unit 310, a process detection unit 320, and a voltage detection unit 330. FIG. 3 illustrates that the condition detection circuit 255 includes all of the temperature detection unit 310, the process detection unit 320, and the voltage detection unit 330. However, in another embodiment, the condition detection circuit 255 may include one or two of these elements 310, 320, and 330.

The temperature detection unit 310 is configured to detect the temperature of the memory 110 and output temperature information TEMP<0:3>. In an embodiment, the temperature detection unit 310 may be configured to use a circuit such as an on-die thermal sensor (ODTS). In general, when a temperature of the memory is low, the memory is in a good condition.

The process detection unit 320 is configured to detect the process variations of the memory 110 and output process information PROCESS<0:3>. The process information PROCESS<0:3> indicates whether internal elements of the memory 110 operate at a high speed or a low speed. Such a different operation speed of the internal elements results from the process variations occurred during a fabrication process of the memory 110. In general, when the internal elements of the memory 110 operate at a high speed, the internal elements are in a good condition.

The voltage detection unit 330 is configured to detect a change in a power supply voltage VDD applied to the memory 110, and to output voltage information VOL<0:3> indicating whether the power supply voltage VDD is stably provided.

Table 1 below shows examples of the process information PROCESS<0:3>, the voltage information VOL<0:3>, and the temperature information TEMP<0:3>. These types of information include a 4-bit signal, wherein upper two bits <2:3> of the 4-bit signal indicate a type of information and lower two bits <0:1> of the 4-bit signal indicate a state of a condition corresponding to the type of information.

TABLE 1

| | <0:3> | Condition |
|---|---|---|
| PROCESS | 0000 | GOOD |
| PROCESS | 0001 | NOT GOOD |
| PROCESS | 0010 | BAD |
| PROCESS | 0011 | DANGER |
| VOL | 0100 | GOOD |
| VOL | 0101 | NOT GOOD |
| VOL | 0110 | BAD |
| VOL | 0111 | DANGER |
| TEMP | 1000 | GOOD |
| TEMP | 1001 | NOT GOOD |
| TEMP | 1010 | BAD |
| TEMP | 1011 | DANGER |

FIG. 4 is a block diagram of the process detection unit 320 of FIG. 3 in accordance with an embodiment.

Referring to FIG. 4, the process detection unit 320 includes a ring oscillator 410 and a period detection section 420.

The ring oscillator 410 is configured to generate a periodic wave OSC. The ring oscillator 410 includes inverters serially connected to each other in a chain. A frequency of the periodic wave OSC is increased when the inverters operate at a high speed, and is decreased when the inverters operate at a low speed. That is, the frequency of the periodic wave OSC is changed according to an operational speed of the internal elements (e.g., the inverters) of the memory 110.

The period detection section 420 is configured to detect a period of the periodic wave OSC and generate the process information PROCESS<0:3>. A value of the process information PROCESS<0:3> is small when the period of the periodic wave OSC detected by the period detection section 420 is short, and is large when the period of the periodic wave OSC detected by the period detection section 420 is long.

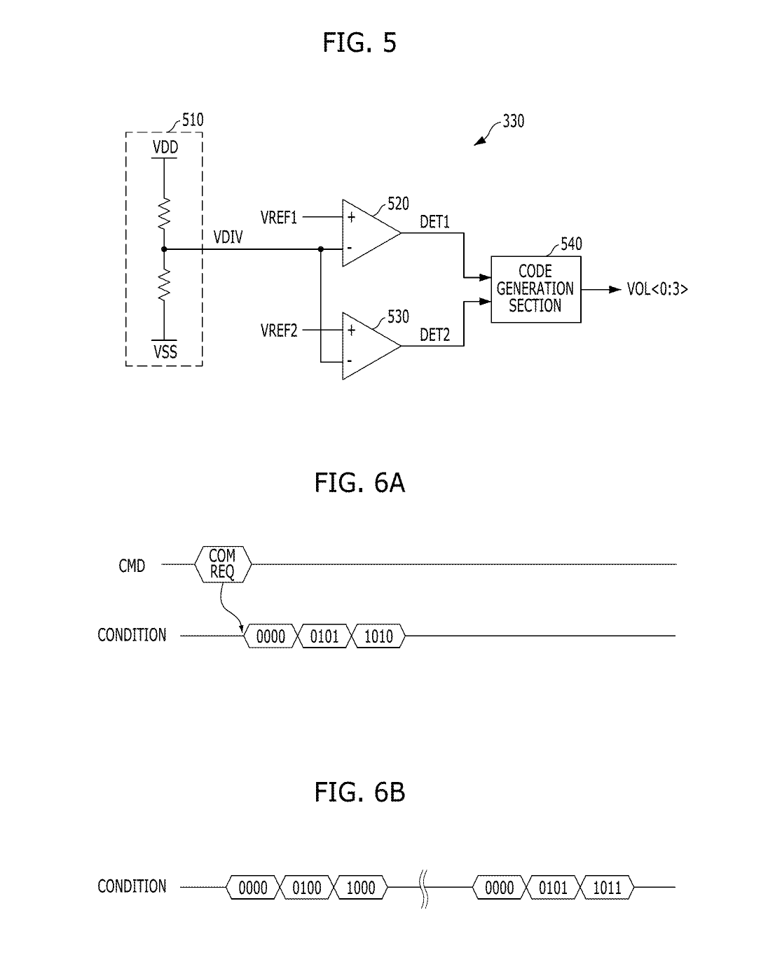

FIG. 5 is a block diagram of the voltage detection unit 330 of FIG. 3 in accordance with an embodiment.

Referring to FIG. 5, the voltage detection unit 330 includes a voltage division section 510, comparators 520 and 530, and a code generation section 540.

The voltage division section 510 is configured to generate a divided voltage VDIV by dividing the power supply voltage VDD. The divided voltage VDIV has a voltage level obtained by dividing the power supply voltage VDD with a predetermined division ratio, so that the divided voltage VDIV is appropriately compared with the reference voltages VREF1 and VREF2. For example, the divided voltage VDIV may have a level corresponding to a half of the level of the power supply voltage VDD. Although the following description will be based on the assumption that the divided voltage VDIV has a level corresponding to a half of the level of the power supply voltage VDD, embodiments of the present disclosure are not limited thereto.

The comparator 520 is configured to compare the divided voltage VDIV with the reference voltage VREF1. When the divided voltage VDIV has a higher level than that of the reference voltage VREF1, the comparator 520 outputs a detection signal DET1 having a value of ‘0’. When the divided voltage VDIV has a lower level than that of the reference voltage VREF1, the comparator 520 outputs a detection signal DET1 having a value of ‘1’. In this embodiment, the reference voltage VREF1 has a level corresponding to 45% of a normal level of the power supply voltage VDD. Accordingly, when the level of the power supply voltage VDD is equal to or more than 90% of the normal level, the detection signal DET1 has a value of ‘0’. When the level of the power supply voltage VDD is below 90% of the normal level, the detection signal DET1 has the value of ‘1’. In other words, the detection signal DET1 has a value of ‘1’ when a voltage drop of 10% or more in the power supply voltage VDD occurs during operation of the memory 110.

The comparator 530 is configured to compare the divided voltage VDIV with the reference voltage VREF2. When the divided voltage VDIV has a higher level than that of the reference voltage VREF2, the comparator 530 outputs a detection signal DET2 having a value of ‘0’. When the divided voltage VDIV has a lower level than that of the reference voltage VREF2, the comparator 530 outputs a detection signal DET2 having a value of ‘1’. In this embodiment, the reference voltage VREF2 has a level corresponding to 40% of the normal power supply voltage VDD. Accordingly, when the level of the power supply voltage VDD is equal to or more than 80% of the normal level, the detection signal DET2 has a value of ‘0’. When the level of the power supply voltage VDD is below 80% of the normal level, the detection signal DET2 has a value of ‘1’. Thus, the detection signal DET2 has a value of ‘1’ when a voltage drop of 20% or more in the power supply voltage VDD occurs during the operation of the memory 110. It is important that the reference voltages VREF1 and VREF2 used in the comparators 520 and 530 are maintained at a substantially constant level, respectively. For example, the reference voltages VREF1 and VREF2 may be generated using a bandgap circuit.

The code generation section 540 is configured to generate the voltage information VOL<0:3> using the detection signals DET1 and DET2. The code generation section 540 increases code values of the voltage information VOL<0:3> using the detection signals DET1 and DET2 as the power supply voltage VDD becomes instable. In an embodiment, the code generation section 540 may generate the voltage information VOL<0:3> by counting a number of times the detection signals DET1 and DET2 have a value of ‘1’ for a predetermined time (e.g., 1000 clock cycles). For example, (1) when the detection signals DET1 and DET2 do not have a value of ‘1’ at all for the predetermined time, the voltage information VOL<0:3> may be (0,1,0,0), (2) when the detection signal DET1 has a value of ‘1’ once or twice and the detection signal DET2 does not have a value of ‘1’ at all for the predetermined time, the voltage information VOL<0:3> may be (0,1,0,1), (3) when the detection signal DET1 has a value of ‘1’ three or four times and the detection signal DET2 does not have a value of ‘1’ at all for the predetermined time, the voltage information VOL<0:3> may be (0,1,1,0), and (4) when the detection signal DET1 has a level of ‘1’ five times or more, or the detection signal DET2 has a level of ‘1’ once or more for the predetermined time, the voltage information VOL<0:3> may be (0,1,1,1).

FIG. 6A and FIG. 6B are diagrams illustrating transmission of the memory condition CONDITION from the memory 110 to the memory controller 120.

FIG. 6A illustrates that the memory condition CONDITION is transmitted from the memory 110 to the memory controller 120 in response to a request from the memory controller 120. Referring to FIG. 6A, using the command CMD (i.e., COM REQ), the memory controller 120 requests the memory 110 to transmit the memory condition CONDITION. In response to the request, the memory 110 transmits the memory condition CONDITION to the memory controller 120. For example, as shown in FIG. 6A, the memory condition CONDITION, which includes the process information having the GOOD condition (0,0,0,0), the voltage information having the NOT GOOD condition (0,1,0,1), and the temperature information having the BAD condition (1,0,1,0), is transmitted.

FIG. 6B illustrates that the memory condition CONDITION is transmitted from the memory 110 to the memory controller 120 at a predetermined time interval (e.g., 10⁹ clock cycles). Referring to FIG. 6B, the memory condition CONDITION, which includes the process information having the GOOD condition (0,0,0,0), the voltage information having the GOOD condition (0,1,0,0), and the temperature information having the GOOD condition (1,0,0,0), is transmitted. After the predetermined time elapses, the memory condition CONDITION, which indicates the process information having the GOOD condition (0,0,0,0), the voltage information having the NOT GOOD condition (0,1,0,1), and the temperature information having the DANGER (1,0,1,1), is transmitted.

Transmission of the memory condition CONDITION from the memory 110 to the memory controller 120 may be performed in response to the request of the memory controller 120 as illustrated in FIG. 6A, or may be performed at a predetermined time interval as illustrated in FIG. 6B. In another embodiment, the memory condition CONDITION may be transmitted from the memory 110 to the memory controller 120 in real time.

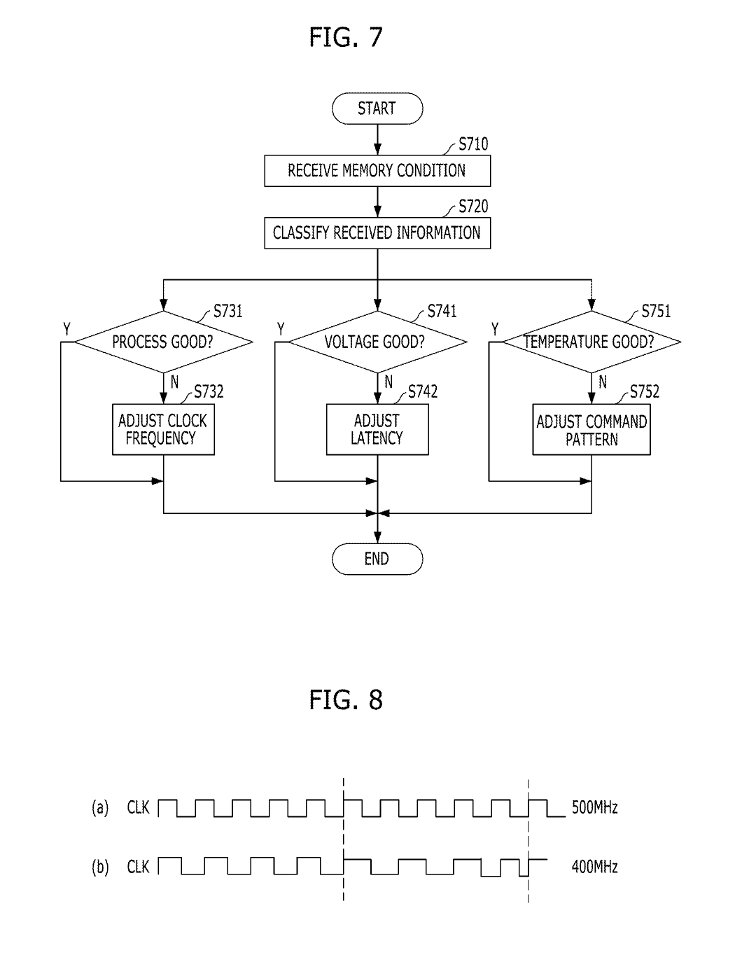

FIG. 7 is a flowchart illustrating an embodiment in which the memory controller 120 adjusts operational performance of the memory 110 in response to the memory condition CONDITION received from the memory 110.

Referring to FIG. 7, at S710, the memory controller 120 receives the memory condition transmitted from the memory 110. At S720, the received memory condition is classified into process information, voltage information, or temperature information. When the received memory condition is (0,0,X,X), the memory condition is classified into the process information and S731 is subsequently performed. When the received memory condition is (0,1,X,X), the memory condition is classified into the voltage information and S741 is subsequently performed. When the received memory condition is (1,0,X,X), the memory condition is classified into the temperature information and S751 is subsequently performed.

At S731, whether the process information has the GOOD condition is determined. When the process information has the GOOD condition, a frequency of the clock CLK is not adjusted. However, when the process information does not have the GOOD condition, the memory controller 120 adjusts the frequency of the clock CLK applied to the memory 110 at S732. A degree of the adjustment of the frequency of the clock CLK may be determined based on how much operational performance of the memory 110 has been adversely affected by variations of process parameters, which is indicated by the condition included in the process information. Specifically, the frequency of the clock CLK is reduced as the condition becomes worse. For example, when the normal frequency of the clock CLK (e.g., the frequency under the GOOD condition) is 500 MHz, the frequency of the clock CLK may be adjusted to 475 MHz if the condition is NOT GOOD. If the condition is BAD and DANGER, the frequency of the clock CLK may be adjusted to 450 MHz and 400 MHz, respectively. In an embodiment, the frequency of the clock CLK supplied to the memory 110 may be adjusted by controlling a clock generator (not shown) in the memory controller 120.

At S741, whether the voltage information has the GOOD condition is determined. When the voltage information has the GOOD condition, latency is not adjusted. However, when the voltage information does not have the GOOD condition, the adjustment for the latency is performed at step S742. A degree of the adjustment for the latency is determined based on how much a level of the power supply voltage VDD deviates from a normal voltage level, which is indicated by the condition included in the voltage information. Specifically, the latency is increased as the condition becomes worse. For example, when a normal latency (e.g., the latency under the GOOD condition) is N, the latency may be adjusted to N+1 if the condition is NOT GOOD. If the condition is BAD and DANGER, the latency may be adjusted to N+2 and N+3, respectively. The adjusted latency may include CAS latency (CL) or write latency (WL). In another embodiment, both types of latency or other types of latency may be adjusted. The latency adjustment may be performed by transmitting an MRS command and an address ADD from the memory controller 120 to the memory 110.

At S751, whether the temperature information has the GOOD condition is determined. When the temperature information has the GOOD condition, a command pattern is not adjusted. However, when the temperature information does not have the GOOD condition, an adjustment for the command pattern (e.g., a command sequence) is performed at S752. The adjustment for the command pattern may be determined based on how much a temperature of the memory 110 deviates from a desired operation temperature, which is indicated by the condition included in the temperature information. Specifically, more non-operation (NOP) commands are inserted between valid commands as the condition becomes worse. For example, when the condition is NOT GOOD, the command pattern may be adjusted such that one NOP command is inserted between every three valid commands. When the condition is BAD and DANGER, the command pattern may be adjusted such that one NOP command is inserted between every two valid commands and every one valid command, respectively.

In an embodiment of FIG. 7, the clock frequency is adjusted according to the process information, the latency is adjusted according to the voltage information, and the command pattern is adjusted according to the temperature information. However, another embodiment may have a different one-to-one correspondence relationship from the above embodiment. For example, the latency may be adjusted according to the process information, the command pattern may be adjusted according to the voltage information, and the clock frequency may be adjusted according to the temperature information. Other embodiments may not have an one-to-one correspondence relationship. For example, all of the clock frequency, the latency, and the command pattern may be changed in response to one type of information among the process information, the voltage information, or the temperature information. Furthermore, the operational performance (e.g., the clock frequency, the latency, and the command pattern) of the memory may also be adjusted according to a combination of two or more of the process information, the voltage information, and the temperature information.

FIG. 8 is a waveform diagram illustrating how a frequency of the clock CLK applied to the memory 110 is adjusted by the memory controller 120.

In FIG. 8, (a) illustrates the clock CLK applied to the memory 110 when the process information has the GOOD condition. In this case, the clock CLK has a frequency of 500 MHz. In FIG. 8, (b) illustrates the clock CLK applied to the memory 110 when the process information has the DANGER condition. In this case, the clock CLK has a frequency of 400 MHz. When the process information has the GOOD condition, the memory 110 operates at a high speed in synchronization with the 500 MHz clock. Meanwhile, when the process information has the DANGER condition, this means that the memory 110 may have a relatively poor performance due to variations of the process parameters occurred during its fabrication process. Since the memory 110 may malfunction at such a high speed (e.g., in synchronization with the 500 MHz clock), the memory 110 operates at a lower speed in synchronization with the 400 MHz clock to ensure the operational stability of the memory 110.

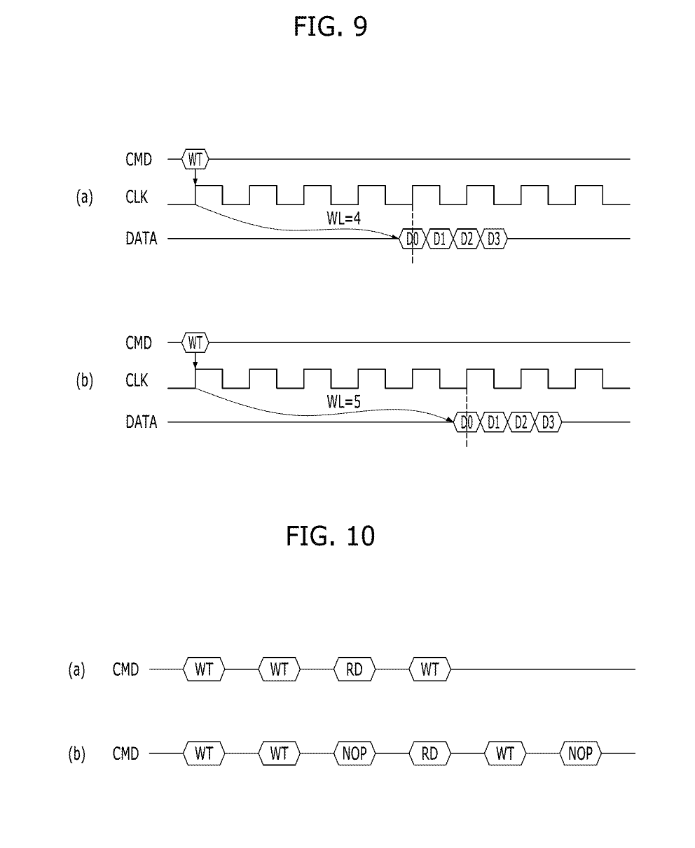

FIG. 9 is a diagram illustrating how the write latency WL of the memory 110 is adjusted by the memory controller 120.

In FIG. 9, (a) illustrates the write latency WL without an adjustment by the memory controller 120, when the voltage information has the GOOD condition. As shown in FIG. 9, (a), four types of data D0 to D3 are inputted after four clock cycles from the time when a write command WT has been applied. In this case, the write latency WL is 4.

In FIG. 9, (b) illustrates that the write latency WL is adjusted to 5, when the voltage information has the NOT GOOD condition. As shown in (b) of FIG. 9, the four types of data D0 to D3 are inputted after five clock cycles from the time when the write command WT has been applied. In this case, the write latency is 5.

FIG. 10 is a diagram illustrating how a pattern of the command CMD applied to the memory 110 is adjusted by the memory controller 120.

In FIG. 10, (a) illustrates a command pattern CMD applied from the memory controller 120 to the memory 110 when the temperature information has the GOOD condition. As shown in (a) of FIG. 10, the command pattern CMD (i.e., write WT, write WT, read RD, and write WT commands) are applied without an NOP (Non-Operation) command between two commands.

In FIG. 10, (b) illustrates a command pattern CMD applied from the memory controller 120 to the memory 110 when the temperature information has the BAD condition. It is assumed that the command pattern CMD applied by the memory controller 120 is the same as that in (a) of FIG. 10. As shown in (b) of FIG. 10, the command pattern CMD includes a series of six commands (i.e., write WT, write WT, NOP, read RD, write WT, and NOP). That is, the NOP command is inserted after two consecutive commands. This aims at securing a margin for the operation of the memory 110, so that the temperature of the memory 110 decreases.

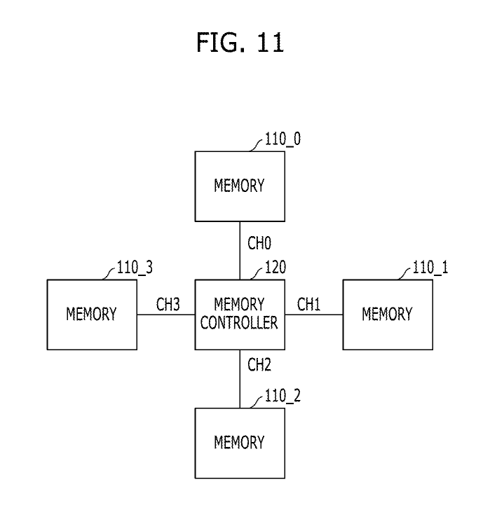

FIG. 11 is a block diagram of a memory system in accordance with another embodiment.

Referring to FIG. 11, the memory system includes a plurality of memories 110_0 to 110_3 and a memory controller 120. The memory controller 120 controls the plurality of memories 110_0 to 110_3 through separate channels CH0 to CH3. Each of the channels CH0 to CH3 illustrated in FIG. 11 may include a plurality of subchannels through which the CMD, the ADD, the DATA, and the CONDITION are transmitted as illustrated in FIG. 1.

The memory controller 120 receives a memory condition CONDITION from each of the memories 110_0 to 110_3. Using the memory condition CONDITION received from each of the memories 110_0 to 110_3, the memory controller 120 adjusts the performance of each of the memories 110_0 to 110_3, respectively. For example, when the memory conditions of the memories 110_0, 110_2, and 110_3 include the GOOD condition and the memory condition of the memory 110_1 includes the BAD condition, the memory controller 120 controls the memories 110_0, 110_2, and 110_3 to operate with high performance and controls the memory 110_1 to operate with low performance. That is, when the plurality of memories 110_0 to 110_3 are provided in the memory system, the memory controller 120 is able to control the performance of the memories 110_0 to 110_3 according to the memory conditions of the memories 110_0 to 110_3.

While the present disclosure has been described with respect to the specific embodiments, it will be apparent to those skilled in the art that various changes and modifications may be made without departing from the spirit and scope of embodiments of the invention as defined in the following claims.

Particularly, the aforementioned embodiments have described a DRAM of memories as an example. However, the present disclosure can be used in order to control the performance of memories according to the conditions of the memories in all types of memories, such as a flash memory, STT-MRAM, or PC-RAM, as well as the DRAM.

What is claimed is:

1. A memory system comprising:
a memory including a condition detection circuit configured to detect a memory condition and a condition output circuit configured to output the memory condition detected by the condition detection circuit; and
a memory controller configured to adjust operational performance of the memory in response to the memory condition.

2. The memory system of claim 1, wherein the condition detection circuit comprises:
a temperature detection unit configured to detect a temperature of the memory,
wherein the memory condition includes temperature information.

3. The memory system of claim 1, wherein the condition detection circuit comprises:
a process detection unit configured to detect a process variation of the memory,
wherein the memory condition includes process information.

4. The memory system of claim 3, wherein the process detection unit comprises:
a ring oscillator configured to generate a periodic wave; and
a period detection section configured to detect a period of the periodic wave and generate the process information.

5. The memory system of claim 1, wherein the condition detection circuit comprises:
a voltage detection unit configured to detect a power supply voltage of the memory,
wherein the memory condition includes voltage information.

6. The memory system of claim 5, wherein the voltage detection unit comprises:
a voltage division section configured to divide a power supply voltage and generate a divided voltage;
a voltage comparator configured to compare the divided voltage with one or more reference voltages; and
a code generation section configured to generate the voltage information using a result of the comparison by the voltage comparator.

7. The memory system of claim 1, wherein the condition detection circuit comprises:
a temperature detection unit configured to detect a temperature of the memory;
a process detection unit configured to detect a process variation of the memory; and
a voltage detection unit configured to detect a power supply voltage of the memory,
wherein the memory condition includes temperature information, process information, and voltage information.

8. The memory system of claim 1, wherein the memory controller is configured to adjust a clock frequency of the memory in response to the memory condition.

9. The memory system of claim 1, wherein the memory controller is configured to adjust a latency of the memory in response to the memory condition.

10. The memory system of claim 9, wherein the latency of the memory includes one or more of a column address strobe (CAS) latency and a write latency.

11. The memory system of claim 1, wherein the memory controller is configured to adjust a pattern of a command, which is applied to the memory, in response to the memory condition.

12. The memory system of claim 1, wherein the memory controller is configured to adjust a clock frequency of the memory, a latency of the memory, and a pattern of a command in response to the memory condition, the command being applied to the memory.

13. The memory system of claim 1, wherein the memory condition is periodically transmitted from the memory to the memory controller.

14. The memory system of claim 1, wherein the memory controller is configured to apply a request command of transmitting the memory condition to the memory, and the memory is configured to transmit the memory condition to the memory controller in response to the request command.

15. The memory system of claim 1, wherein a plurality of memories are provided in the memory system, and the memory controller is configured to independently adjust operational performance of each of the plurality of memories in response to a memory condition received from each of the plurality of memories.

16. A memory comprising:
a temperature detection unit configured to detect a temperature of the memory;
a process detection unit configured to detect a process variation of the memory;
a voltage detection unit configured to detect a power supply voltage of the memory; and
a condition output circuit configured to output a memory condition,
wherein the memory condition includes a result of the detection by the temperature detection unit, a result of the detection by the process detection unit, and a result of the detection by the voltage detection unit.

17. The memory of claim 16, wherein the condition output circuit is configured to periodically output the memory condition.

18. The memory of claim 16, wherein the condition output circuit is configured to output the memory condition in response to a request command received from a memory controller.

19. An operation method of a memory controller, comprising:
receiving a memory condition from a memory;
determining whether the memory condition is in a bad condition; and
adjusting performance of the memory when it is determined that the memory condition is in the bad condition.

20. The operation method of claim 19, wherein the memory condition includes one or more of temperature information, process information, and voltage information of the memory, and
adjusting of the performance comprises adjusting of one or more of, a clock frequency of the memory, a latency of the memory, and a pattern of a command applied to the memory.
